(19) United States
(12) Patent Application Publication
(10) Pub. No.: US 2019/0222719 A1
(43) Pub. Date: Jul. 18, 2019

(54) IMAGE PROCESSING APPARATUS AND IMAGE FORMING APPARATUS

(71) Applicant: Hidenori SHINDOH, Tokyo (JP)

(72) Inventor: Hidenori SHINDOH, Tokyo (JP)

(21) Appl. No.: 16/203,689

(22) Filed: Nov. 29, 2018

(30) Foreign Application Priority Data
Jan. 18, 2018 (JP) 2018-006591

(51) Int. Cl. H04N 1/62; H04N 1/60

(52) U.S. Cl. CPC H04N 1/62; H04N 1/6016

(57) ABSTRACT

An image processing apparatus includes circuitry configured to store, in a memory, a primary image to be processed; accept an input of a selected area of the primary image stored in the memory and an input of a designated color for the selected area; and perform image processing to change a color of the selected area of the primary image to the designated color, to generate a secondary image.

### CROSS-REFERENCE TO RELATED APPLICATIONS

This patent application is based on and claims priority pursuant to 35 U.S.C. § 119(a) to Japanese Patent Application No. 2018-006591, filed on Jan. 18, 2018, in the Japan Patent Office, the entire disclosure of which is hereby incorporated by reference herein.

### BACKGROUND

### Technical Field

Embodiments of the present disclosure generally relate to an image processing apparatus and an image forming apparatus.

### Description of the Related Art

Image forming apparatuses such as multifunction peripherals (MFPs) can store print data sent from personal computers (PCs) or the like. In addition, image forming apparatuses can accept designation of print data selected from the stored print data and print the designated print data.

There is a technique of replacing plain data of color components, in cyan, magenta, yellow, and black (CMYK) color space, of the color of print data, to change the color of the print data after being stored.

### SUMMARY

According to an embodiment of this disclosure, an image processing apparatus includes circuitry configured to store, in a memory, a primary image to be processed; accept an input of a selected area of the primary image stored in the memory and an input of a designated color for the selected area; and perform image processing. In the image processing, the selected area of the primary image is changed to have the designated color, and a secondary image is generated.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram illustrating an example configuration of an image processing system according to an embodiment of the present disclosure;

FIG. 2 is a block diagram illustrating an example software configuration of an image processing apparatus according to an embodiment;

FIG. 3 is a block diagram illustrating an example hardware configuration of the image processing apparatus illustrated in FIG. 2, according to an embodiment;

FIG. 4 is a functional block diagram of the image processing apparatus illustrated in FIG. 2;

FIG. 5 is a front view illustrating an example graphical user interface (GUI) displayed on a control panel according to an embodiment;

FIGS. 6A and 6B are diagrams illustrating example image processing in an image processing unit according to an embodiment;

FIG. 7 is a diagram illustrating example image processing in the image processing unit; and

FIG. 8 is a flowchart that schematically illustrates a flow of operation in color change processing according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

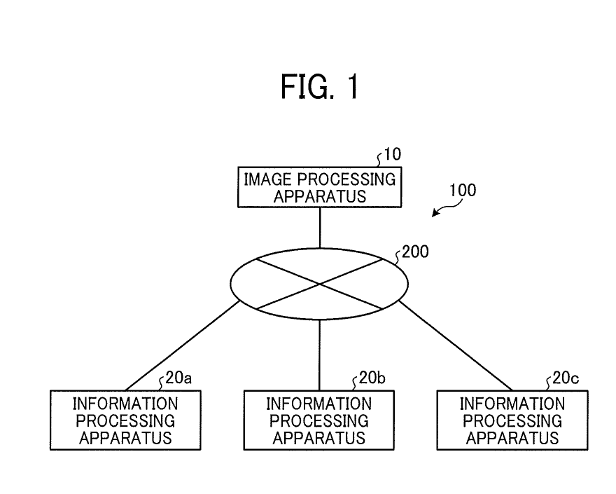

Referring now to the drawings, wherein like reference numerals designate identical or corresponding parts throughout the several views thereof, and particularly to FIG. 1, an image processing system according to an embodiment of this disclosure is described. As used herein, the singular forms “a”, “an”, and “the” are intended to include the plural forms as well, unless the context clearly indicates otherwise.

Configuration of Image Processing System

FIG. 1 is a schematic diagram illustrating an image processing system 100 according to the present embodiment. The image processing system 100 according to the present embodiment includes an image processing apparatus 10, an information processing apparatus 20a, an information processing apparatus 20b, and an information processing apparatus 20c. Hereinafter, the information processing apparatus 20a, the information processing apparatus 20b, and the information processing apparatus 20c are simply referred to as “information processing apparatuses 20” when discrimination therebetween is not necessary.

The image processing apparatus 10 and the information processing apparatuses 20 are connected to each other via a network 200. The communication method of the network 200 can be either wireless or wired. Further, in the network 200, wired communication can be combined with wireless communication.

The image processing apparatus 10 is, for example, an MFP, which is an image forming apparatus. Further, the information processing apparatuses 20 are, for example, personal computers, smart devices, or the like.

Software Configuration of Image Processing Apparatus

Next, an example software configuration of the image processing apparatus 10 will be described. Computer programs (software) executed in the image processing apparatus 10 according to the present embodiment can be stored, in a file format installable into a computer or executable by the computer, in a computer readable recording medium, such as a compact disc read only memory (CD-ROM), a flexible disk (FD), a compact disc recordable (CD-R), and a digital versatile disk (DVD).

Alternatively, the computer programs (software) executed in the image processing apparatus 10 according the present embodiment can be stored in a computer connected to a network such as the Internet and downloaded through the network. Alternatively, the computer programs (software) executed in the image processing apparatus 10 according to the present embodiment can be supplied or distributed via a network such as the Internet.

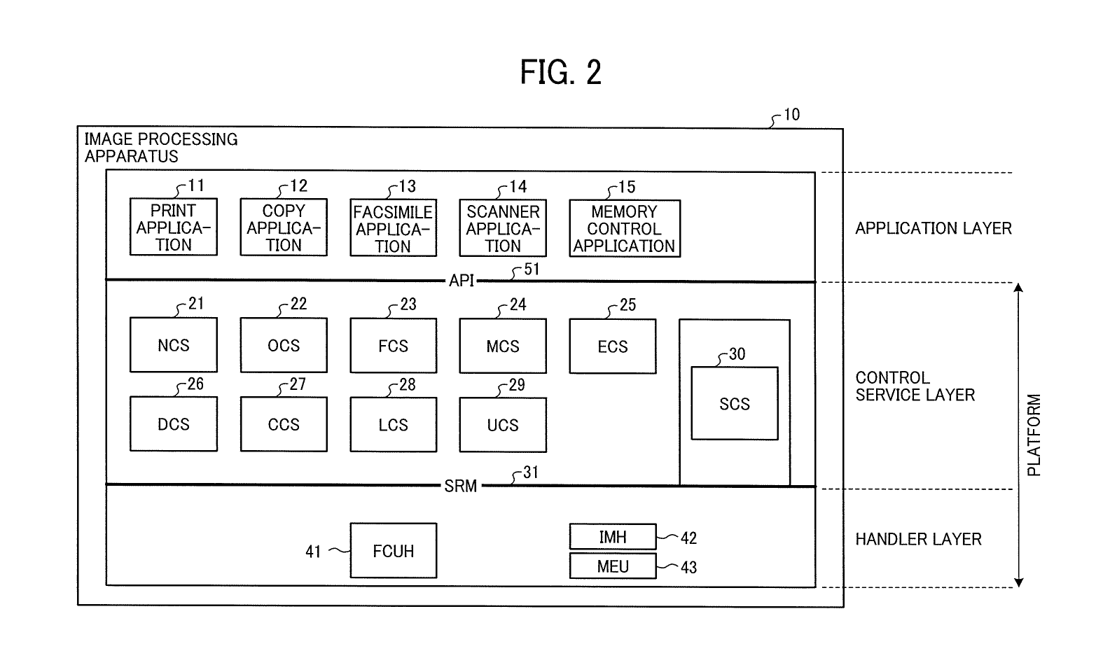

FIG. 2 is a block diagram illustrating an example software configuration of the image processing apparatus 10. The image processing apparatus 10 includes software of an application layer (application layer software) and software of a platform. The software of the platform includes software of a control service layer (control service layer software) and software of a handler layer (handler layer software). Note that a portion of or entire software of the image processing apparatus 10 can be implemented by hardware.

The software of the platform receives a processing request from the application layer software with an application programming interface (API) 51. The API 51 is a function predetermined for the application layer software to execute processing for using the control service layer software.

The application layer software and the platform software operate on an operating system (OS), for example, UNIX (registered trademark). The OS executes the application layer software and the platform software in parallel as processes.

The application layer software performs processing for realizing the service that the image processing apparatus 10 provides to the user.

The application layer includes a print application 11, a copy application 12, a facsimile application 13, a scanner application 14, and a memory control application 15. The print application 11 performs processing to control printing. The copy application 12 performs processing to control copying. The facsimile application 13 performs processing to control facsimile communication. The scanner application 14 performs processing to control the scanner function.

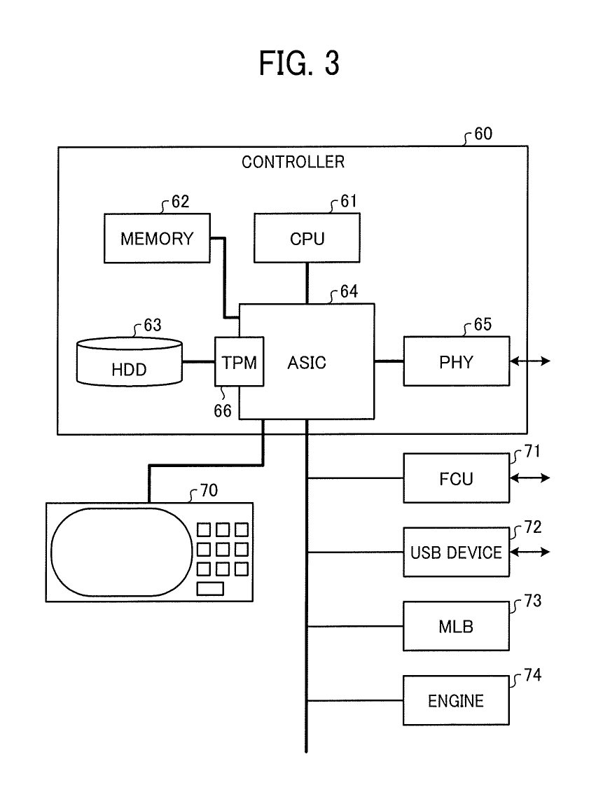

The memory control application 15 performs storage control processing such as reading, adding, changing, and deleting of information. Information stored in the image processing apparatus 10 is stored in a memory 62 and a hard disk drive (HDD) 63 (see FIG. 3) described later. Further, the memory control application 15 sets access privileges of the information stored in the image processing apparatus 10. The setting of access privileges is, for example, sharing setting to allow access from a plurality of users or the like. Note that some or all of the processing performed by the memory control application 15 can be executed by the OS.

The control service layer software receives the processing request from the application layer software and transmits a hardware resource acquisition request to a system resource manager (SRM) 31, based on the processing request. The SRM 31 is to be described later.

The control service layer includes a network control service (NCS) 21, a control panel control service (OCS) 22, a facsimile control service (FCS) 23, a memory control service (MCS) 24, an engine control service (ECS) 25, a delivery control service (DCS) 26, a certification and charge control service (CCS) 27, a log control service (LCS) 28, a user control service (UCS) 29, and a system control service (SCS) 30.

The NCS 21 performs communication control processing for software requiring a network input or output (I/O). Specifically, the NCS 21 distributes data received from the information processing apparatuses 20, via the network 200, according to various protocols to each software operating on the image processing apparatus 10. Further, the NCS 21 transmits, according to various protocols, data received from each software operating in the image processing apparatus 10 to the information processing apparatuses 20 connected to the network 200.

The OCS 22 performs control processing of an operation panel (control panel) that accepts an operation input by a user.

In response to a request from the facsimile application 13, the FCS 23 performs facsimile transmission and reception, using public switched telephone network (PSTN) or integrated services digital network (ISDN). Further, in response to a request from the facsimile application 13, the FCS 23 performs, for example, processing to register facsimile data in a backup memory, processing to extract the facsimile data from the backup memory, processing to read the facsimile data, and processing to print the facsimile data received.

The MCS 24 performs storage control processing such as acquiring and releasing the memory used by each software and writing data in and reading data from the HDD 63.

The ECS 25 performs processing to control an engine 74 (see FIG. 3) that is hardware to perform scanning, printing, and the like.

The DCS 26 performs processing to control, for example, distribution of information stored in the image processing apparatus 10.

The CCS 27 controls processing relating to user authentication and accounting of a service realized by the image processing apparatus 10.

The user authentication can be optional. The user authentication is, for example, a process of reading an identification (ID) card for identifying a user, a process of checking a combination of user identification information and a password, and the like.

In the process of reading the ID card, the identification information of the user included in the ID card is read from the ID card with a reading device using, for example, near field communication (NFC).

The process of checking the combination of the user identification information and the password includes accepting the input of the user identification information and the password and collating the user identification information and the password with the user identification information and the password stored in the image processing apparatus 10. In the case where the image processing apparatus 10 is used from the information processing apparatus 20 via the network 200, for example, the image processing apparatus 10 receives the user identification information and the password from the information processing apparatus 20 and authenticates the user of the information processing apparatus 20.

The LCS 28 controls storing of logs output from the software operating in the image processing apparatus 10.

The UCS 29 performs user information control processing, such as reading, adding, changing, and deleting the user information. The user information is, for example, the user identification information and the password used for user authentication.

The SCS 30 performs control processing such as management of software, control of an operation unit such as a control panel, display of system screens, display of a light emitting diode (LED), management of hardware resources, and control of application interruption.

The SRM 31 performs control of the system of the image processing apparatus 10 and hardware resources, together with the SCS 30. For example, the SRM 31 receives hardware resource acquisition requests from upper layer software that uses hardware, such as a plotter, included in the engine 74 (see FIG. 3), performs arbitration of the hardware resource acquisition requests received from each software, and allocates at least one hardware resources according to the hardware resource acquisition requests.

Specifically, the SRM 31 determines whether or not the hardware resource specified by the hardware resource acquisition request is available (whether the hardware resource has been already used in response to a hardware resource acquisition request received from another software). When the hardware resource specified by the hardware resource acquisition request is available, the SRM 31 reports that the hardware resource is available, to the upper layer software that has transmitted the hardware resource acquisition request.

In addition, the SRM 31 determines a schedule of each hardware resource acquisition request received from the upper layer, thereby instructing execution of the operation (for example, paper conveyance, image formation, memory reservation, and file generation) specified by each hardware resource acquisition request. When an execution instruction is issued to the engine 74 (see FIG. 3) directly from the SRM 31, an engine interface (I/F) is used. The engine I/F is a function predefined for requesting processing to the engine 74.

The handler layer software receives the hardware resource acquisition request from the SRM 31 and acquires the hardware resource corresponding to the hardware resource acquisition request.

The handler layer includes a facsimile control unit handler (FCUH) 41, an image memory handler (IMH) 42, and a media edit utility (MEU) 43.

The FCUH 41 receives, from the SRM 31, a hardware resource acquisition request for a facsimile control unit (FCU) 71 (see FIG. 3) and controls the operation of the FCU 71. Note that the above-described engine I/F is used similarly when the FCUH 41 transmits the processing request to the FCU 71.

The IMH 42 receives, from the SRM 31, the hardware resource acquisition request for the memory and controls the allocation of the memory used by the upper layer software.

The MEU 43 receives, from the SRM 31, a hardware resource acquisition request and controls operation of hardware that performs image processing such as image conversion.

Descriptions are given below of, as an operation example of the above software, processing performed when the image processing apparatus 10 performs copying.

First, the OCS 22, the CCS 27, and the UCS 29 perform authentication processing of the user. Specifically, when the OCS 22 receives an operation input indicating the identification information and the password of the user, the OCS 22 transmits the identification information and the password of the user to the CCS 27. In response to an acceptance of the user identification information and the password from the OCS 22, the CCS 27 confirms whether or not the combination of the user identification information and the password is stored in the image processing apparatus 10 via the UCS 29, thereby authenticating the user.

Next, the OCS 22 accepts an operation input, such as pressing of a copy button, indicating an instruction to activate the copy application 12.

Next, the copy application 12 requests the MCS 24 to acquire the memory to be used for the copy processing and requests the ECS 25 to control the reading by the engine 74 (see FIG. 3). Then, the software of a lower service layer (the SCS 30 and the SRM 31) executes the processing. The SRM 31 exchanges information with the engine 74 via the engine I/F. Meanwhile, the data output from the engine 74 is held in a memory that is controlled by the IMH 42.

According to the operation input by the user and the setting of the image processing apparatus 10, the IMH 42 records an image on the HDD 63 (see FIG. 3) and requests the MEU 43 to execute image processing such as image conversion.

As a modified image (a secondary image described below) in which the color has been changed partially or entirely by the ECS 25 is input to the engine 74, the engine 74 prints the image (the secondary image) in which the color has been changed partially or entirely.

The LCS 28 stores, in the image processing apparatus 10, a log of a series of processes from the user authentication to the printing performed by each software described above.

Hardware Configuration of Image Processing Apparatus

A hardware configuration of the image processing apparatus 10 is described below.

FIG. 3 is a block diagram illustrating an example hardware configuration of the image processing apparatus 10. The image processing apparatus 10 includes a controller 60, a control panel 70, the FCU 71, a universal serial bus (USB) device 72, a media link board (MLB) 73, and the engine 74.

The controller 60 controls the operation of the image processing apparatus 10. The controller 60 includes a central processing unit (CPU) 61, the memory 62, the HDD 63, an application specific integrated circuit (ASIC) 64, a physical layer chip (PHY) 65, and a trusted platform module (TPM) 66.

The CPU 61 executes the software of the application layer, the control service layer, and the handler layer that control the operation of the image processing apparatus 10.

The memory 62 is a main memory of the image processing apparatus 10. The HDD 63 is an auxiliary memory of the image processing apparatus 10. The HDD 63 stores, for example, the software of the application layer, the control service layer, and the handler layer. The software of the application layer, the control service layer, and the handler layer is read by the CPU 61 from the HDD 63 and is developed in the memory 62.

The ASIC 64 is an integrated circuit that controls the operation of the image processing apparatus 10. The CPU 61, the memory 62, the HDD 63, the PHY 65, the TPM 66, the control panel 70, the FCU 71, the USB device 72, the MLB 73, and the engine 74 are connected to the ASIC 64 via a data transfer bus.

The PHY 65 controls communication with the information processing apparatuses 20 connected to the network 200.

The TPM 66 is a security chip that stores highly confidential information such as an encryption key. The encryption key is, for example, a secret key (decryption key) of public key cryptography or the like. Storing the encryption key not in the HDD 63 but in the TPM 66 is advantageous in reducing the risk of leakage of the encryption key.

For example, to decrypt the data encrypted with a public key of public key cryptography, the TPM 66 decrypts the data using the secret key stored in the TPM 66.

Further, for example, when the copy application 12, the facsimile application 13, or the scanner application 14 generates an image reading request, the TPM 66 records, in the HDD 63, the image encrypted with the encryption key stored in the TPM 66.

The control panel 70 is a user interface that accepts, from the user using the image processing apparatus 10, instructions to execute various jobs and input of setting and displays, to the user, various information. The control panel 70 includes a touch panel.

The FCU 71 is a control unit that controls the facsimile function of the image processing apparatus 10.

The USB device 72 is an interface for connecting a USB device.

The MLB 73 is a conversion board that performs format conversion of image data.

The engine 74 includes a scanner engine for reading images, a plotter engine for printing, and the like. The engine 74 serves as an image forming device.

Functional Configuration of Image Processing Apparatus

Next, descriptions are given below of an example functional configuration of the image processing apparatus 10 realized by cooperation of the hardware and the software described above.

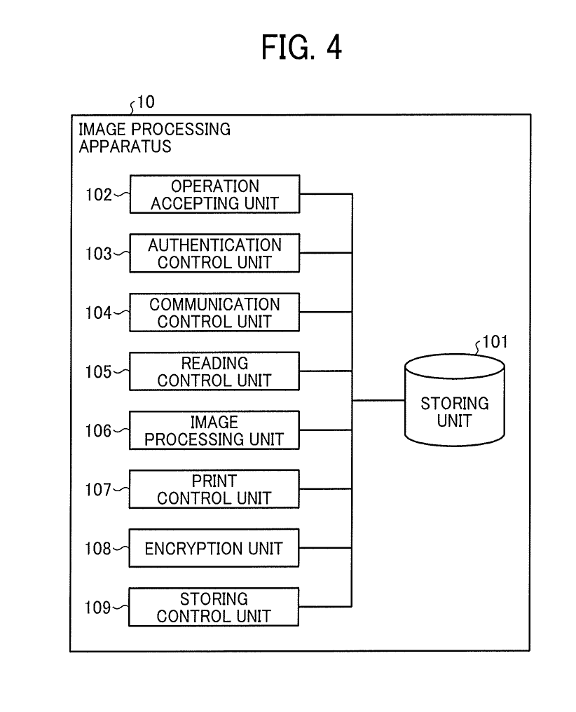

FIG. 4 is a functional block diagram illustrating the example functional configuration of the image processing apparatus 10. The image processing apparatus 10 includes a storing unit 101, an operation accepting unit 102, an authentication control unit 103, a communication control unit 104, a reading control unit 105, an image processing unit 106, a print control unit 107, an encryption unit 108, and a storing control unit 109.

The storing unit 101 stores information. The information stored in the storing unit 101 is, for example, a log indicating the operation of each function of the image processing apparatus 10 performed according to an instruction from the user authenticated by the authentication control unit 103. Further, for example, the information stored in the storing unit 101 is the secondary image described later.

The operation accepting unit 102 accepts an operation input from the user.

The authentication control unit 103 authenticates the user by the above-described authentication process.

The communication control unit 104 performs processing for communicating with the information processing apparatuses 20 connected to the network 200. For example, the communication control unit 104 receives, from the information processing apparatus 20, an image that is subject to processing, such as color change, by the image processing apparatus 10. The image subject to processing (hereinafter “primary image”) is, for example, an image representing information created by document creation software or the like of the information processing apparatus 20.

The reading control unit 105 reads, as a primary image, information recorded on a recording medium such as a paper sheet. The data format of the primary image read by the reading control unit 105 is not limited. The data format of the primary image read by the reading control unit 105 is, for example, JPEG (Joint Photographic Experts Group) format, TIFF (Tagged Image File Format), or PDF (Portable Document Format).

The storing control unit 109 stores the information in the storing unit 101. The storing control unit 109 stores, for example, the above-described primary image in the storing unit 101.

The image processing unit 106 performs image processing (e.g., color change processing) for changing the color of the primary image after the primary image is stored in the storing unit 101, to generates a modified image (secondary image). The data format of the secondary image can be either the same as or different from the data format of the primary image.

More specifically, the operation accepting unit 102 displays the primary images stored in the storing unit 101 on the control panel 70. Further, the operation acceptance unit 102 accepts an input of a selected area (either a partial area or an entire area) of the primary image displayed on the control panel 70 and an input of a designation color for the selected area.

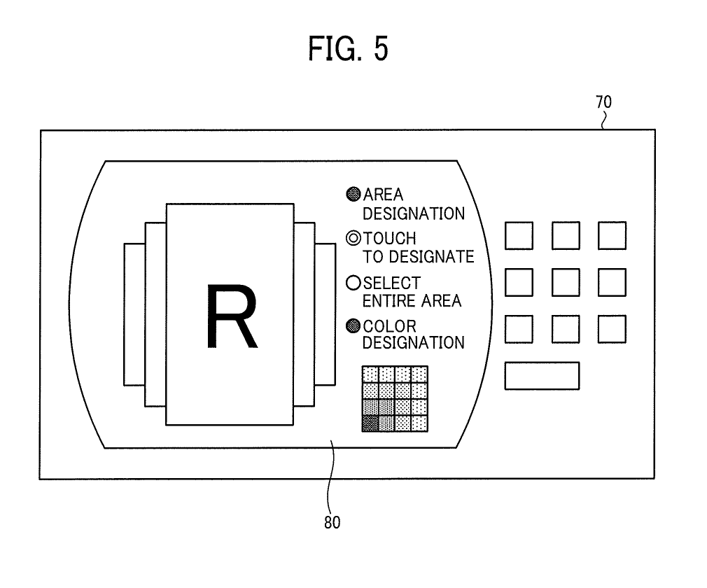

FIG. 5 is a front view illustrating an example of a graphical user interface (GUI) 80 displayed on the control panel 70. As illustrated in FIG. 5, the control panel 70 displays the GUI 80 that selectively displays primary images stored in the storing unit 101. For example, the GUI 80 scrolls all the primary images stored in the storing unit 101 to be selected. The user scrolls the screen and selects a desired primary image via the touch panel.

Further, the GUI 80 enables the user to select a partial area or an entire area of the primary image displayed on the control panel 70. For example, to select a portion of the primary image, after operating a radio button “Touch to designate” on the GUI 80, the user selects the portion of the primary image on the GUI 80 via the touch panel. Alternatively, the user operates a radio button “Select entire area” of the GUI 80 to select the entire area of the primary image.

Further, the GUI 80 enables designation of a color for the selected area of one primary image displayed on the control panel 70. The user designates a desired color via the GUI 80 and the touch panel.

The image processing unit 106 decomposes print data of the selected area of the primary image stored in the storing unit 101 into plain data (color data) of each color component in a first color space, which in the present embodiment is the CMYK color space. In addition, the image processing unit 106 acquires the designated color in a second color space, which in the present embodiment is red, green, and blue (RGB) color space, designated for the selected area of the primary image stored in the storing unit 101, and executes arithmetic processing to redistribute the designated color into the first color space (CMYK color space) and generate plain data (converted plain data) of each color component in the first color space. The term “redistribution” means that yellow data is generated from RGB and also cyan data is converted in the original CMYK print data in a case in which green color of RGB color space is changed to yellow color of CMYK color space.

Then, the image processing unit 106 replaces the plain data of each color component for the selected area of the primary image with the plain data of each color component after redistribution (color conversion), thereby generating the secondary image.

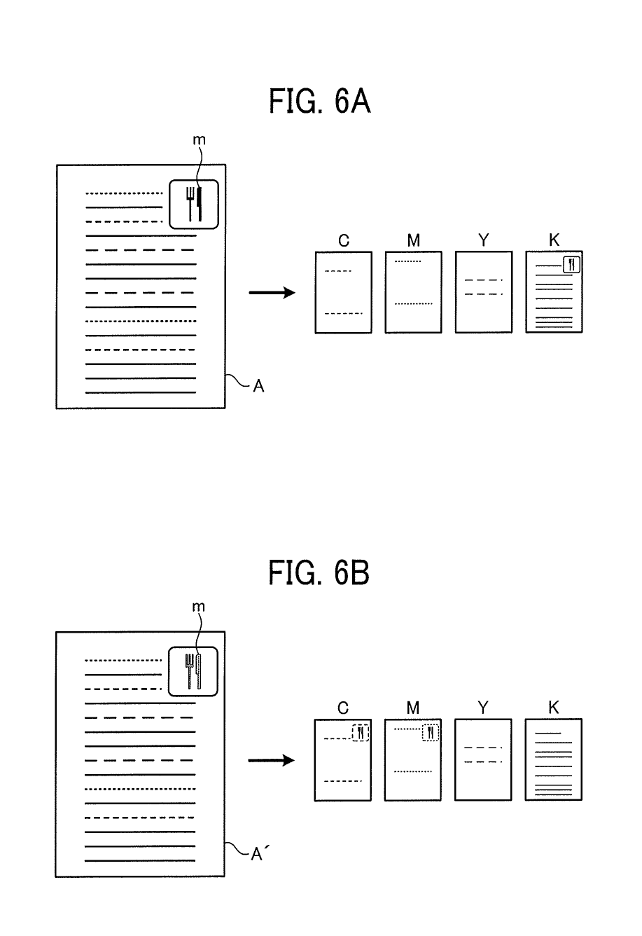

FIGS. 6A and 6B are diagrams illustrating example image processing in the image processing unit 106. FIGS. 6A and 6B illustrate an example in which the color of a portion of a primary image A is changed. In this example, in the primary image A, a black illustration m at the upper right in FIG. 6A is selected, and a secondary image A′ in which the color of the illustration m is changed to green is generated as illustrated in FIG. 6B. In this case, as the color of the upper right illustration m in the primary image A is changed from black to, for example, green as illustrated in FIG. 6B, data of the illustration m is decomposed into cyan plain data and magenta plain data, and black plain data of the illustration m is deleted.

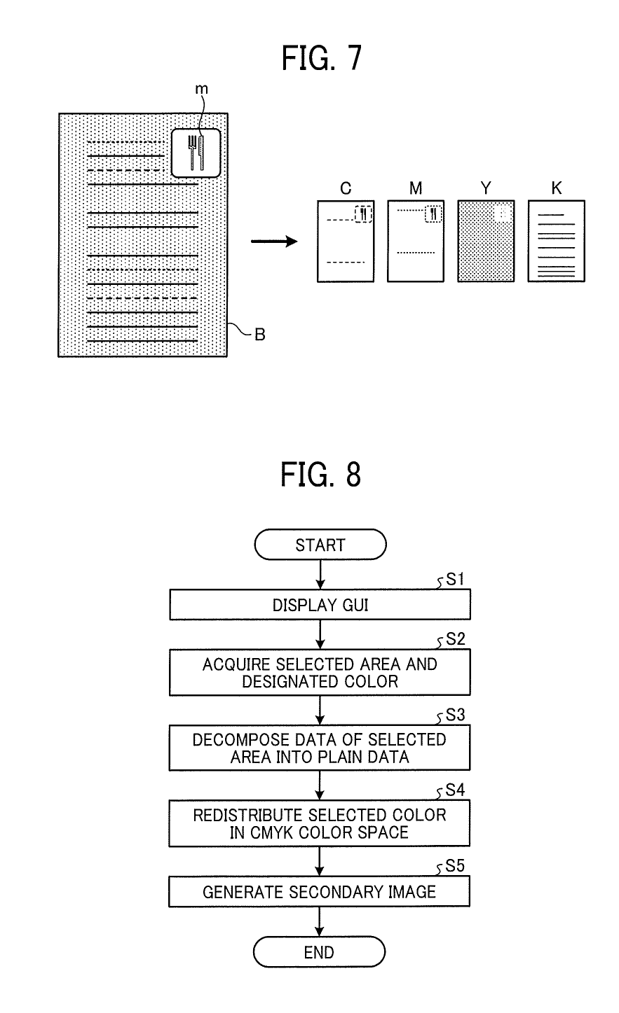

FIG. 7 is a diagram illustrating an example of image processing in the image processing unit 106. In the example illustrated in FIG. 7, the color of a portion of a primary image B having a background color of yellow is changed. Specifically, in the primary image B, the upper right black illustration m is selected, and the color of the illustration m is changed to green. In this case, as illustrated in FIG. 7, the yellow plain data interferes with the cyan plain data and the magenta plain data for the illustration m, resulting in an unwanted change in color tone. Accordingly, the illustration m portion of the yellow plain data is made void.

That is, with reference to the color component value of the user-designated color (CMYK color space) of the primary image, the image processing unit 106 adjusts the entire color and generates the secondary image. Alternatively, the image processing unit 106 can designate a range (level) of the color component value of the designated color (CMYK color space) of the primary image, refers to the range (level), and adjust the color of the area that satisfies the range (level), to generate the secondary image.

The image processing unit 106 stores the above-described secondary image in the storing unit 101 via the storing control unit 109.

The storing control unit 109 stores, for example, the above-described secondary image in the storing unit 101.

The print control unit 107 prints the primary image or the secondary image.

The encryption unit 108 performs encryption processing of part or all of the information processed by the image processing apparatus 10 and decryption processing of encrypted information. The information to be encrypted and decrypted is information stored in the storing unit 101, information transmitted and received via the information processing apparatus 20 to and from the network 200, and the like.

Further, for example, the storing control unit 109 stores, in the storing unit 101, a log indicating the result of the above-described authentication processing by the authentication control unit 103. The log indicating the authentication result includes, for example, the date and time of the authentication process, the identification information for identifying the user, and the authentication result (whether the authentication has succeeded or failed).

Further, for example, when receiving the primary image from the information processing apparatus 20, the storing control unit 109 stores a log including identification information for identifying the user of the information processing apparatus 20, from which the primary image has been transmitted, in the storing unit 101.

Note that the information used to identify the primary image on the log is, for example, the data name of the primary image and the hash value calculated from the primary image. The data name of the primary image is obtained from, for example, a print job transmitted from the information processing apparatus 20. The hash value of the primary image can be calculated by the information processing apparatus 20 or can be calculated when the storing control unit 109 stores the log.

Further, for example, when the reading control unit 105 reads the information recorded on the recording medium, such as paper, as the primary image, the storing control unit 109 stores, in the storing unit 101, a log including identification information for identifying the user who has input an instruction to read the primary image.

Further, for example, when the image processing unit 106 generates the secondary image, the storing control unit 109 stores, in the storing unit 101, a log including the identification information of the user who has generated the secondary image. The identification information of the user who has generated the secondary image is the identification information of the user of the information processing apparatus 20 that has transmitted the primary image from which the secondary image has been generated, or the identification information of the user of the information processing apparatus 20 that has input an operation for reading the primary image from which the secondary image has been generated. The information used to identify the secondary image on the log is similar to the case of the primary image, and the description thereof is omitted.

Further, for example, when the print control unit 107 prints the secondary image, the storing control unit 109 stores, in the storing unit 101, a log including identification information for identifying the user who printed the secondary image.

Color Change Processing

Next, the flow of the color change processing will be described.

FIG. 8 is a flowchart that schematically illustrates a flow of operation in the color change processing according to the present embodiment. Note that the color change processing illustrated in FIG. 8 is on the premise that the authentication of the user is successful.

As illustrated in FIG. 8, the operation accepting unit 102 displays the GUI 80 on the control panel 70 (S1). On the GUT 80, the user selects one of the primary images stored in the storing unit 101, selects a partial area or entire area of the selected primary image, and designates a color to which the user desires to change the color of the selected area.

In S2, the image processing unit 106 acquires, via the GUI 80, the selected area of the primary image and the designated color (S2).

In S3, the image processing unit 106 decomposes the print data of the selected area of the primary image into plain data of each color component in the CMYK color space.

In S4, the image processing unit 106 acquires the color in the RGB color space designated for the selected area of the primary image and executes arithmetic processing for redistributing the designated color (generating plain data of each color component) in CMYK color space.

In S5, regarding the selected area of the primary image, the image processing unit 106 replaces the plain data of each color with the plain data of each color after redistribution (converted plain data), thereby generating the secondary image.

The secondary image thus generated is stored in the storing unit 101 as necessary. Further, the secondary image is printed via the print control unit 107.

As described above, according to the present embodiment, the color components can be known from the stored data of the area selected at the time of printing, and the arithmetic processing can be performed according to the designated color to again distribute the color components in the CMYK color space, to generate the plain data of color components thereof. Accordingly, the color of a portion of or entire print data stored in the storing unit 101 can be changed. Particularly, the color in the stored data itself can be changed, thus obviating the need for preparing a plurality of color variations of the print data. For example, the user desires to change the color of a heading of each monthly submission, the print data of which has already been stored in the storing unit 101 (the memory), to make the heading more noticeable. In such a case, according to the present embodiment, regarding the print data stored in the storing unit 101, the color of the heading of each monthly submission can be easily changed, to emphasize letters and marks to be noted after the print data is stored.

Although the image forming apparatus according to the above-described embodiment is an MFP having at least two of copy function, print function, scanner function, and facsimile transmission function, aspects of this disclosure are applicable to other type image forming apparatuses such as copiers, printers, scanners, and facsimile machines.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image processing apparatus comprising:
circuitry configured to:
store, in a memory, a primary image to be processed;
accept an input of a selected area of the primary image stored in the memory and an input of a designated color for the selected area; and
perform image processing to change a color of the selected area of the primary image to the designated color, to generate a secondary image.

2. The image processing apparatus according to claim 1, wherein the circuitry is configured to decompose data of the selected area of the primary image to generate plain data of each color component in a first color space;
wherein the designated color for the selected area is a color in a second color space different from the first color space; and
wherein the circuitry is configured to:
acquire the designated color in the second color space;
perform arithmetic processing to redistribute the designated color in the first color space to generate converted plain data of each color component; and
replace the plain data of each color component for the selected area with the converted plain data, to generate the secondary image.

3. The image processing apparatus according to claim 2, wherein the circuitry is configured to:
refer to a range of the designated color in the second color space; and
redistribute the designated color in the first color space, for an area of the primary image satisfying the referred range of the designated color.

4. The image processing apparatus according to claim 1, wherein the circuitry is configured to store the secondary image in the memory.

5. An image forming apparatus comprising:
the image processing apparatus according to claim 1; and
an image forming device configured to print the secondary image processed by the image processing apparatus.
